(19) United States
(12) Patent Application Publication
(10) Pub. No.: US 2024/0086393 A1
(43) Pub. Date: Mar. 14, 2024

(54) CLUSTER COUNT SETTING APPARATUS, CLUSTER COUNT SETTING METHOD AND PROGRAM

(71) Applicant: NIPPON TELEGRAPH AND TELEPHONE CORPORATION, Tokyo (JP)

(72) Inventors: Shoko TAKAHASHI, Tokyo (JP); Daisuke IKEGAMI, Tokyo (JP)

(21) Appl. No.: 18/262,808

(22) PCT Filed: Feb. 5, 2021
(86) PCT No.: PCT/JP2021/004400

§ 371 Date: Jul. 25, 2023

(51) Int. Cl. G06F 16/23; G06F 16/22; G06F 16/28

(52) U.S. Cl. CPC G06F 16/2365; G06F 16/2264; G06F 16/285

(57) ABSTRACT

A cluster number setting device includes a memory, and a processor configured to: input time series data representing a state of a system and configured by data of a dimension of the number of devices constituting the system, a dimension of the number of items representing the number of devices×states of the devices, or a dimension of the number of devices×the number of items×a predetermined time window length; repeatedly cluster data constituting the time series data while counting up the number of clusters from 1 or 2; calculate a predetermined index by using a result of the clustering; determine whether the index is less than a preset threshold; and output the current number-1 of clusters as the number of clusters to be set for unsteady fluctuation detection processing that uses clustering processing, when the index is determined to be less than the threshold.

### TECHNICAL FIELD

The present invention relates to a cluster number setting device, a cluster number setting method, and a program.

### BACKGROUND ART

There have been known techniques for detecting unsteady fluctuations of a system constituted by one or more devices by using time series data representing a system state at each time point. The unsteady fluctuations here means state fluctuations of the system that occur unsteadily, and examples thereof include a state fluctuation accompanying a failure of some of devices included in the system, and a state fluctuation accompanying the occurrence of an external factor affecting the system state. For example, when a data item representing a system state at each time point is the “number of requests processed” of each device constituting the system, unsteady fluctuation is determined as a decrease in the number of requests processed of some devices due to a failure of the devices and an increase in the number of requests processed of other devices due to the decrease in the number of requests processed, an increase or a decrease in the total number of requests processed associated with the occurrence of an event affecting the system state. For example, when the number of devices constituting the system is M and the number of items of data representing the system state at each time point is K, the data can be represented by an M×K-dimensional vector, so that when the number of time points is N, the time series data representing the system state at each time point of the system constituted by one or more devices is constituted by N pieces of M×K-dimensional data.

In general, when an abnormality such as an unsteady fluctuation is detected by using data to which a correct label is not given, an abnormal value (outlier) deviating from a steady state of the system is detected after the steady state is defined. As a technique for detecting an abnormal value from data of a plurality of dimensions (including one dimension) as described above, for example, a technique described in NPL 1 or NPL 2 has been known.

For example, observation values of the number of requests processed of M devices from time point 1 to time point N are obtained as time series data (that is, time series data composed of N pieces of M-dimensional data), and it is assumed that each piece of M-dimensional data does not contain an abnormal value, or that even if it contains an abnormal value, the number of abnormal values is overwhelmingly small. At this time, if it is assumed that the steady state of each device is not changed, the number of requests processed of each device is considered to be distributed around a fixed value, so that M-dimensional distribution can be assumed in which the number of requests processed is distributed around a fixed value for N pieces of M-dimensional data. NPL 1 proposes a method in which an M-dimensional normal distribution is assumed as the above-mentioned M-dimensional distribution, and then a Mahalanobis' generalized distance from a sample average of the M-dimensional normal distribution is calculated every time new M-dimensional data is observed, to determine abnormality according to the calculated value. NPL 2 proposes a method in which N pieces of M-dimensional data are classified into clusters by a clustering method such as a K-Means method, and a label indicating normality or abnormality is given to each cluster on the basis of some rule such as an empirical rule, and thereafter abnormality is determined from the label of the cluster having the closest cluster center every time new M-dimensional data is observed.

The methods proposed in NPL 1 and NPL 2 described above focus on the state of the system at each time point (that is, the snapshot of the system at each time point). For this reason, for example, in the case of a system in which a steady fluctuation (also referred to as “steady fluctuation,” hereinafter) of a system state is repeated by a periodic fluctuation such as a time fluctuation and a week fluctuation even in a steady state, it is difficult for the methods proposed by NPL 1 and NPL 2 to distinguish the steady fluctuation from other unsteady fluctuations, and there is a possibility that a steady fluctuation may be erroneously detected as an unsteady fluctuation or that unsteady fluctuations may be undetected. On the other hand, NPL 3 proposes an abnormality determination method that focuses on system state transitions over time. By focusing on system state transitions over time, the method proposed in NPL 3 makes it possible to detect unsteady fluctuations as distinguished from steady fluctuations of the system state.

### CITATION LIST

### Non Patent Literature

[NPL 1] N. Ye et al., “An anomaly detection technique based on a chi-square statistic for detecting intrusions into information systems,” Quality and Reliability Engineering, Vol. 17 (2), 2001.

[NPL 2] G. Munz et al., “Traffic Anomaly Detection Using K-Means Clustering,” Computer Science, 2007.

[NPL 3] Takahashi, Ikegami, “Proposal of unsteady fluctuation Detection Technique for Multidimensional Time Series Data,” IEICE Technical Report, CQ2020-32, pp. 57-62, July 2020.

### SUMMARY OF INVENTION

### Technical Problem

However, NPL 3 described above proposes a method capable of detecting unsteady fluctuations as distinguished from steady fluctuations of the system state, but does not describe a method of setting parameters required in the method. That is, in the method described in NPL 3, clustering processing is performed on the input of N pieces of M×K-dimensional data (N: the number of time points, M: the number of devices constituting the system, and K: the number of items of data representing the system state at each time point), but NPL 3 does not describe a method for appropriately setting the number of clusters.

Even when employing either a hierarchical method that does not explicitly specify the number of clusters (e.g., a shortest distance method, a longest distance method, a group average method, a Ward's method, and the like) or a non-hierarchical method that explicitly specifies the number of clusters (for example, K-Means method or the like) as a clustering method used in the clustering processing, how many clusters the N pieces of M×K-dimensional data should be classified into needs to be eventually determined, and if the number of clusters is not appropriately set, unsteady fluctuations cannot be detected appropriately. This is because in a system whose steady state is a state where a steady fluctuation is repeated, it is desirable that the steady state is divided into a plurality of clusters and that the steady fluctuation is modeled as a steady state cluster transition pattern However, if the number of clusters is too small, the steady state cannot be divided into a plurality of clusters, and the steady fluctuation cannot be modeled, but if the number of clusters is too large, a fine disturbance in the steady fluctuation is considered as a different cluster transition pattern and is over-detected as an unsteady fluctuation.

An embodiment of the present invention has been made in view of the points described above, and an object thereof is to enable appropriate setting of the number of clusters necessary in an unsteady fluctuation detection technique where clustering processing is used.

### Solution to Problem

In order to achieve the object, a cluster number setting device according to an embodiment includes: a time series data input unit that inputs time series data representing a system state, at each time point, of a system configured by one or more devices, the time series data being configured by data of a dimension of the number of devices constituting the system, a dimension of the number of items representing the number of devices×states of the devices, or a dimension of the number of devices×the number of items×a predetermined time window length; a clustering unit that repeatedly clusters data constituting the time series data while counting up the number of clusters from 1 or 2; a cluster-related index calculation unit that calculates a predetermined index by using a result of the clustering; a threshold determination unit that determines whether or not the index is less than a preset threshold; and an output unit that outputs the current number-1 of clusters as the number of clusters to be set for unsteady fluctuation detection processing that uses clustering processing, when the index is determined to be less than the threshold.

### Advantageous Effects of Invention

The number of clusters necessary for the unsteady fluctuation detection technique where clustering processing is used can be set appropriately.

### BRIEF DESCRIPTION OF DRAWINGS

FIG. 1 is a diagram showing an example of a functional configuration of a cluster number setting device according to the present embodiment.

FIG. 2 is a flowchart showing an example of cluster number setting processing according to the present embodiment.

FIG. 3 is a diagram showing an example of a hardware configuration of the cluster number setting device according to the present embodiment.

### DESCRIPTION OF EMBODIMENTS

Hereinafter, an embodiment of the present invention will be described. The present embodiment describes a cluster number setting device 10 capable of appropriately setting the number of clusters which is a main parameter of an unsteady fluctuation detection technique where clustering processing is used, by using time series data representing a system state at each time point of a system constituted by one or more devices. Here, as the unsteady fluctuation detection technique using clustering processing, for example, the unsteady fluctuation detection technique described in NPL 3 is assumed. In this unsteady fluctuation detection technique, after a fluctuation in the system state is extracted as a cluster transition pattern by the clustering processing, it is determined which cluster transition pattern is a steady fluctuation or an unsteady fluctuation according to the occurrence frequency, thereby detecting an unsteady fluctuation.

By combining the cluster number setting device 10 according to the present embodiment with the unsteady fluctuation detection technique proposed in NPL 3 and appropriately setting the number of clusters which is the main parameter thereof, unsteady fluctuations can be detected with a high degree of accuracy as distinguished from steady fluctuations. Further, since the number of clusters is appropriately set, there is no need for human determination, for example, as to whether the number of clusters is appropriate or not.

Thereafter, it is assumed that the time series data is composed of N pieces of M×K-dimensional data, where M is the number of devices constituting the system which is a target of detection of unsteady fluctuations, N is the number of time points, and K is the number of items of data representing the system state at each time point.

Each item value (i.e., each element of an M×K-dimensional vector at each time point) of the M×K-dimensional data at each time point is K observation values representing the state of each device at that time point. More specifically, when the M×K-dimensional data at a certain time point are [x₁, . . . , x_{K}, x_{K+1}, . . . , x_{ZK}, . . . , x_{(M-1)K+1}, . . . , x_{MK}], for example, x_{(m-1)K+1}, . . . , x_{mK} are observation values of the m-th device at the time point. Examples of the observation values include arbitrary values representing state of the device such as the number of requests processed described above, a CPU (Central Processing Unit) usage rate, and a memory usage rate.

### <Functional Configuration>

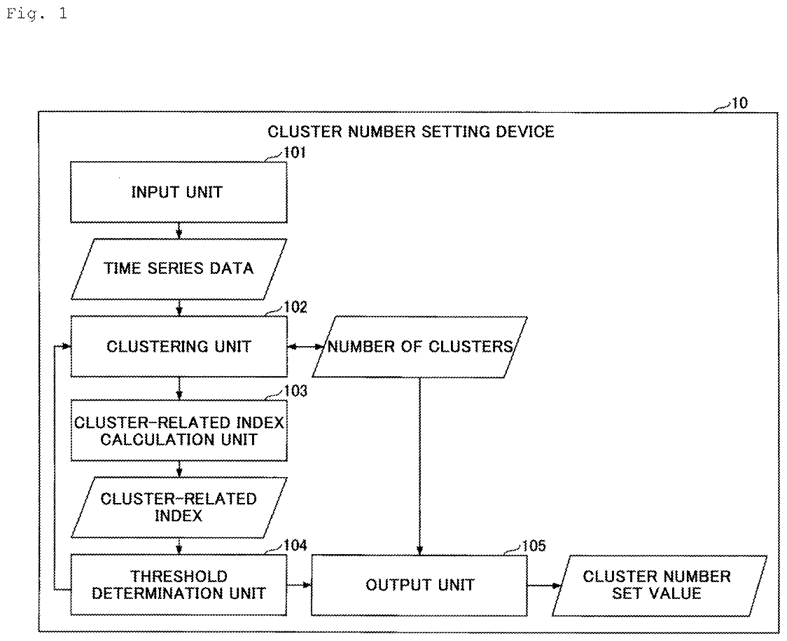

First, a functional configuration of the cluster number setting device 10 according to the embodiment will be described with reference to FIG. 1. FIG. 1 is a diagram showing an example of the functional configuration of the cluster number setting device 10 according to the present embodiment.

As shown in FIG. 1, the cluster number setting device 10 according to the present embodiment includes an input unit 101, a clustering unit 102, a cluster-related index calculation unit 103, a threshold determination unit 104, and an output unit 105.

The input unit 101 inputs time series data composed of N pieces of M×K-dimensional data. Note that the input unit 101 may input the time series data from any input source. For example, the input unit 101 may input time series data by receiving the time series data from a system, a server device, or the like via a communication network, or may input time series data by reading the time series data stored in an auxiliary storage device or the like. For example, the input unit 101 may receive time series data input by a user or the like, and thereby input the time series data.

The clustering unit 102 clusters each piece of M×K-dimensional data constituting the time series data input by the input unit 101. In so doing, the clustering unit 102 repeatedly executes clustering until the threshold determination unit 104, which will be described later, determines that a cluster-related index has fallen below a threshold, while counting up the number of clusters d from a preset initial value.

The cluster-related index calculation unit 103 calculates a cluster-related index each time clustering is executed by the clustering unit 102. Here, the cluster-related index is an index for determining whether or not the current number of clusters is appropriate, and examples of the cluster-related index that can be used include the sum of squares of intra-cluster errors (SSE: Sum of Squared Errors) or minimum distance between centroids, or the first- or second-order difference absolute values of these indices, or the value obtained by taking the ratio of the first- or second-order difference absolute value to an original index (hereafter, the value obtained by taking the ratio of the first-order difference absolute value is also referred to as “first-order difference ratio absolute value” and the value obtained by taking the ratio of the second-order difference absolute value is also referred to as “second-order difference ratio absolute value.”), or a first-order difference absolute value or second-order difference absolute value normalized by the basic statistics of the original series (i.e., the time series data input by the input section 101) (hereinafter, the standardized first-order difference value is also referred to as “standardized first-order difference absolute value” and the standardized second-order difference absolute value is also referred to as “standardized second-order difference absolute value”).

The threshold determination unit 104 compares the cluster-related index calculated by the cluster-related index calculation unit 103 with a preset threshold, and determines whether the cluster-related index is lower than the threshold.

When the threshold determination unit 104 determines that the cluster-related index is lower than the threshold, the output unit 105 outputs the current number-1 of clusters (i.e., the maximum number of clusters in which the cluster-related index is not lower than the threshold) as a cluster number set value used in the unsteady fluctuation detection technique. Note that the output unit 105 may output the cluster number setting value to an arbitrary output destination. For example, the output unit 105 may output a cluster number setting value to a server device or the like for detecting abnormality by the unsteady fluctuation detection technique described above, or may output a cluster number setting value to a memory device or the like of the cluster number setting device 10 when the cluster number setting device 10 itself detects abnormality by the unsteady fluctuation detection technique. In addition, for example, the output unit 105 may output a cluster number set value to a display or the like.

### <Cluster Number Setting Processing>

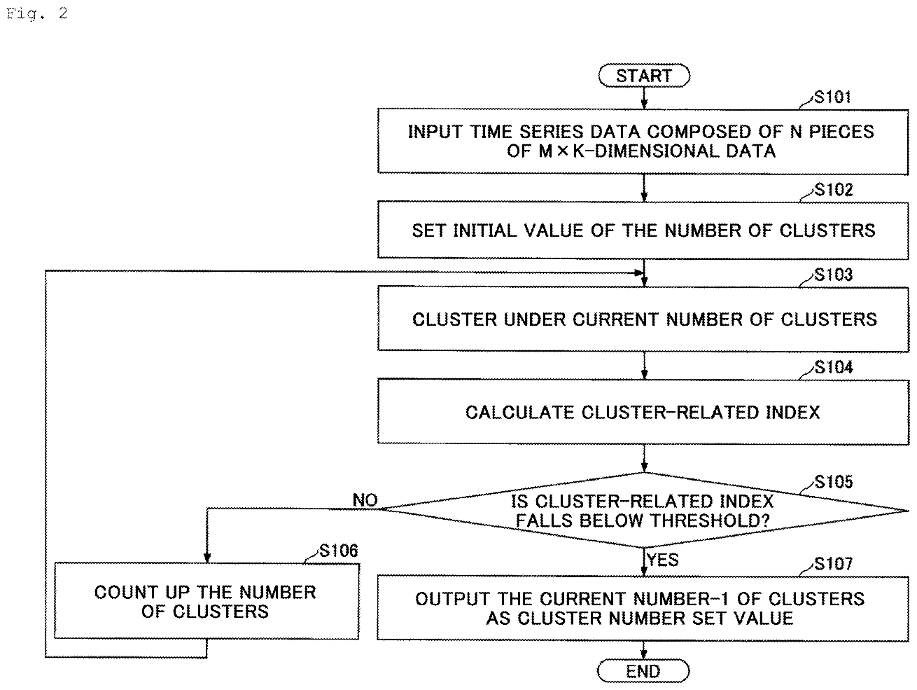

Next, cluster number setting processing according to the present embodiment will be described with reference to FIG. 2. FIG. 2 is a flowchart showing an example of the cluster number setting processing according to the present embodiment.

Step S101: First, the input unit 101 inputs time series data composed of N pieces of M×K-dimensional data. That is, assuming that M×K-dimensional data at time point n is Xₙ, the input unit 101 inputs time series data {X₁, . . . , Xₙ} is input. Prior to step S102 to be described later, predetermined preprocessing may be performed on the time series data {X₁, . . . , X_{N}}. For example, in the case where a device failure is considered as an unsteady fluctuation to be detected by the unsteady fluctuation detection technique, since processing imbalance among devices is observed when some devices fail, normalization processing for converting each item value of each piece of data into a relative value between the devices may be performed as the preprocessing in order to accentuate this imbalance. Specifically, for example, at each time point n=1, . . . , N, the total Sₙₖ of observation values of M devices related to k-th item (where k=1, . . . , K) may be calculated, and the observation value of each device related to the k-th item may be divided by the total Sₙₖ, whereby processing for converting each observation value into a value within the range of [0, 1] may be performed as the preprocessing. Alternatively, for example, for each device and each item, processing (standardization processing) may be performed as the preprocessing to convert the N observation values over the period [1, N] for the k-th item (where k=1, . . . , K) of the m-th device (where m=1, . . . , M) so that the mean is 0 and the standard deviation is 1.

When the level of the observation value of the group of devices constituting the system at the normal time differs greatly depending on the devices, the processing for converting the observation value into a differential sequence for each device and each item may be performed as the preprocessing in order to accentuate the change or change rate that occurs when an unsteady fluctuation occurs. Specifically, when the observation value obtained at the time point n (where n=1, . . . , N) related to the k-th item (where k=1, . . . , K) of the device m (where m=1, . . . , M) is x_{(m-1)K+k}⁽ⁿ⁾, y_{(m-1)K+k}⁽ⁿ⁾=x_{(m-1)K+k}⁽ⁿ⁾−x_{(m-1)K+k}⁽ⁿ⁻¹⁾ is calculated for n=2, . . . , N (that is, first-order difference is calculated), and the M×K-dimensional data of the time point n (where n=2, . . . , N) may be defined as [y₁⁽ⁿ⁾, . . . , y_{K}⁽ⁿ⁾, y_{K+1}⁽ⁿ⁾, . . . , y_{2K}⁽ⁿ⁾, . . . , y_{(M-1)K+1}⁽ⁿ⁾, . . . , y_{MK}⁽ⁿ⁾]. Instead of the first-order difference, the first-order difference absolute value may be calculated. Alternatively, for example, when the ratio between y_{(m-1)K+k}⁽ⁿ⁾ and x_{(m-1)K+k}⁽ⁿ⁻¹⁾ is defined as z_{(m-1)K+k}⁽ⁿ⁾, M×K-dimensional data at the time point n (where n=2, . . . , N) may be defined as [z₁⁽ⁿ⁾, . . . , z_{K}⁽ⁿ⁾, z_{K+1}⁽ⁿ⁾, . . . , z_{2K}⁽ⁿ⁾, . . . , z_{(M-1)K+1}⁽ⁿ⁾, . . . , z_{MK}⁽ⁿ⁾].

Furthermore, N pieces of M×K-dimensional data may be divided by a time window composed of W time points, and M×K×W-dimensional vector composed of M×K-dimensional data at the time points n−(W−1), n−(W−2), . . . , n may be used as M×K×W-dimensional data at the time point n instead of M×K-dimensional data at the time point n. That is, the time series data composed of M×K×W-dimensional data is created from the time series data composed of M×K-dimensional data, and processing subsequent to step S102 to be described later may be executed by using the time series data composed of the M×K×W-dimensional data.

In the case where the group of devices constituting the system is frequently replaced or the sources of unsteady fluctuations are distributed to a large number of devices, the values of the respective items may be sorted among the devices in order to avoid the fluctuation of the M×K-dimensional data or the M×K×W-dimensional data from being distributed in many directions when unsteady fluctuation occurs. For example, if the value of each item of M×K-dimensional data is the first-order difference absolute value of the value of each item of the original M×K-dimensional data as described above, even if the sources of the unsteady fluctuation are distributed to a large number of devices, the values of items corresponding to the devices can be concentrated on the top K×W dimension of the M×K×W-dimensional data, by sorting the first-order difference absolute value among the devices.

Further, for example, unsteady fluctuations that can be easily distinguished from steady fluctuations observed during normal times, such as time fluctuations and weekly fluctuations, may be detected and excluded using the conventional techniques (e.g., techniques described in NPL 1 and NPL 2) before proceeding to step S102 which is described below.

Step S102: Next, the clustering unit 102 sets an initial value of the number of clusters d. Here, when any of the sum of squares of intra-cluster error, the first-order difference absolute value, the second-order difference absolute value, the first-order difference ratio absolute value, the second-order difference ratio absolute value, the standardized first-order difference absolute value, and the standardized second-order difference absolute value is defined as a cluster-related index, the clustering unit 102 sets the initial value of the number of clusters d to 1. On the other hand, if any of the minimum value of the distance between centroids, the first-order difference absolute value, the second-order difference absolute value, the first-order difference ratio absolute value, the second-order difference ratio absolute value, the standardized first-order difference absolute value, or the standardized second-order difference absolute value is defined as a cluster-related index, the clustering unit 102 sets the initial value of the number of clusters d to 2.

Step S103: Next, the clustering unit 102 clusters N pieces of M×K-dimensional data constituting the time series data input in the step S101 described above under the current number of clusters d. That is, the clustering unit 102 clusters these N pieces of M×K-dimensional data into d clusters. In so doing, the clustering unit 102 performs clustering by a clustering method for explicitly specifying the number of clusters, such as a K-Means method.

Step S104: Next, the cluster-related index calculation unit 103 calculates the cluster-related index by using the clustering result obtained in step S103.

As an example of the cluster-related index, the case where the second-order difference ratio absolute value of the sum of squares of intra-cluster error is calculated will be described. However, it is assumed that the value of the current number of clusters is 3 or more.

When M×K-dimensional data Xₙ (where n=1, . . . , N) at each time point n are clustered into d clusters, the sum of squares of intra-cluster error SSE_{d} is calculated as follows.

$${SSE}_{d} = {\sum }_{n = 1}^{N} {‖ {X}_{n} - μ ( {c}^{n} ) ‖}_{2}^{2} \qquad [ Math . 1 ]$$

Here, cⁿ is a cluster to which Xₙ belongs, and μ(cⁿ) is a centroid coordinate of the cluster cⁿ. Further, ∥Xₙ−μ(cⁿ)∥₂ is a Euclidean norm between the M×K-dimensional data Xₙ and the centroid coordinate μ(cⁿ) of the cluster to which the data Xₙ belongs. In this manner, the sum of squares of intra-cluster error is obtained by calculating the sum of squares of Euclidean norm between each piece of M×K-dimensional data Xₙ and the centroid coordinate μ(c) of the cluster to which the data belongs.

At this time, the second-order difference ratio absolute value ASDR of the sum of squares of intra-cluster error is calculated as follows.

ASDR_{d}={(SSE_{d}−SSE_{d-1})−(SSE_{d-1}−SSE_{d-2})}/SSE_{d-2}

Step S105: Next, the threshold determination unit 104 compares the cluster-related index calculated in step S104 described above with a preset threshold, and determines whether the cluster-related index is lower than the threshold. When it is not determined that the cluster-related index is lower than the threshold in this step, the processing proceeds to step S106, and when it is determined that the cluster-related index is lower than the threshold, the processing proceeds to step S107.

The method for determining the threshold can be considered in various ways, but for example, the unsteady fluctuation detection technique should be applied to the input data for a learning period for which the correct answers regarding the occurrence of unsteady fluctuations at each time point are known, by changing the threshold of the cluster-related index in various ways, and the threshold that gives the greatest detection accuracy (e.g., correct answer rate, fit rate, reproduction rate, F value, etc.) should be used among these values.

Step S106: The clustering unit 102 counts up the number of clusters d. That is, the clustering unit 102 updates the number of clusters d by D by d←d+1. After this step, the processing returns to step S103. Thus, the clustering processing is repeatedly executed while counting up the number of clusters d from the initial value until the cluster-related index becomes lower than the threshold.

Step S107: The output unit 105 outputs the current number of clusters d−1 as a cluster number setting value.

As described above, the cluster number setting device 10 according to the present embodiment can determine an appropriate value for the number of clusters, which is a main parameter of the unsteady fluctuation detection technique using where the clustering processing used, by using the time series data representing the system state at each time point of the system constituted by one or more devices. Therefore, it is possible to appropriately set the number of clusters for the clustering processing used in the unsteady fluctuation detection technique proposed in NPL 3 described above, and as a result, it is possible to accurately detect unsteady fluctuations as distinguished from steady fluctuations. The detection of unsteady fluctuations by the unsteady fluctuation detection technique may be performed by the cluster number setting device 10 or by a device different from the cluster number setting device 10.

### <Hardware Configuration>

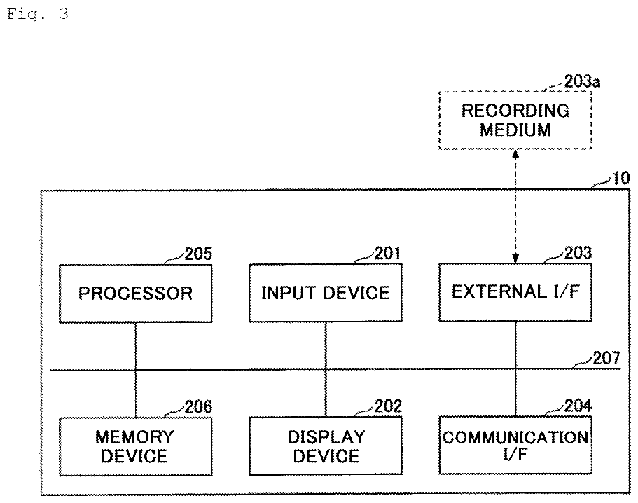

Finally, a hardware configuration of the cluster number setting device 10 according to the present embodiment will be described with reference to FIG. 3. FIG. 3 is a diagram showing an example of the hardware configuration of the cluster number setting device 10 according to the present embodiment.

As shown in FIG. 3, the cluster number setting device 10 according to the present embodiment is implemented by a general computer or computer system and includes an input device 201, a display device 202, an external I/F 203, a communication I/F 204, a processor 205, and a memory device 206. These hardware components are connected via a bus 207 so as to be able to communicate with each other.

The input device 201 is, for example, a keyboard, a mouse, a touch panel, or the like. The display device 202 is, for example, a display or the like. The cluster number setting device 10 may not include at least one of the input device 201 and the display device 202.

The external I/F 203 is an interface with an external device such as a recording medium 203a. The cluster number setting device 10 can read and write the recording medium 203a through the external I/F 203. For example, one or more programs for realizing the functional units of the cluster number setting device 10 (the input unit 101, the clustering unit 102, the cluster-related index calculation unit 103, the threshold determination unit 104, and the output unit 105) may be stored in the recording medium 203a. Note that examples of the recording medium 203a include a CD (Compact Disc), a DVD (Digital Versatile Disc), an SD memory card (Secure Digital Memory Card), and a USB (Universal Serial Bus) memory card.

The communication I/F 204 is an interface for connecting the cluster number setting device 10 to the communication network. Note that one or more programs for realizing each functional unit of the cluster number setting device 10 may be acquired (downloaded) from a predetermined server device or the like via the communication I/F 204.

Examples of the processor 205 include various arithmetic devices such as a CPU and a GPU (Graphics Processing Unit). Each functional unit included in the cluster number setting device 10 is realized, for example, by a processing in which one or more programs stored in the memory device 206 are executed by the processor 205.

Examples of the memory device 206 include various storage devices such as a HDD (Hard Disk Drive), an SSD (Solid State Drive), a RAM (Random Access Memory), a ROM (Read Only Memory), and a flash memory.

The cluster number setting device 10 according to the present embodiment can implement the cluster number setting processing described above by having the hardware configuration shown in FIG. 3. The hardware configuration shown in FIG. 3 is merely an example, and the cluster number setting device 10 may have a different hardware configuration. For example, the cluster number setting device 10 may have a plurality of the processors 205 and a plurality of the memory devices 206.

The present invention is not limited to the foregoing embodiment specifically disclosed, and various modifications and changes, combinations with known technologies, and the like are possible without departing from the description of the claims.

### REFERENCE SIGNS LIST

10 Cluster number setting device
101 Input unit
102 Clustering unit
103 Cluster-related index calculation unit
104 Threshold determination unit
105 Output unit
201 Input device
202 Display device
203 External I/F
203a Recording medium
204 Communication I/F
205 Processor
206 Memory device
207 Bus

1. A cluster number setting device, comprising:
a processor; and
a memory storing program instructions that cause the processor to:
input time series data representing a system state, at each time point, of a system configured by one or more devices, the time series data being configured by data of a dimension of the number of devices constituting the system, a dimension of the number of items representing the number of devices×states of the devices, or a dimension of the number of devices×the number of items×a predetermined time window length;
repeatedly cluster data constituting the time series data while counting up the number of clusters from 1 or 2;
calculate a predetermined index by using a result of the clustering;
determine whether or not the index is less than a preset threshold; and
output the current number-1 of clusters as the number of clusters to be set for unsteady fluctuation detection processing that uses clustering processing, when the index is determined to be less than the threshold.

2. The cluster number setting device according to claim 1, wherein the program instructions cause the processor to calculate, as the index, any of the following:
a sum of squares of intra-cluster error, an inter-centroid distance minimum value, a first-order difference absolute value of the sum of squares of intra-cluster error or the inter-centroid distance minimum value, a second-order difference absolute value of the sum of squares of intra-cluster error or the inter-centroid distance minimum value, a ratio of the first-order difference absolute value of the sum of squares of intra-cluster error to the sum of squares of intra-cluster error, a ratio of the first-order difference absolute value of the inter-centroid distance minimum value to the inter-centroid distance minimum value, a ratio of the second-order difference absolute value of the sum of squares of intra-cluster error to the sum of squares of intra-cluster error, a ratio of the second-order difference absolute value of the inter-centroid distance minimum value to the inter-centroid distance minimum value, the first-order difference absolute value normalized by basic statistics of the time series data, and the second-order difference absolute value normalized by the basic statistics of the time series data.

3. The cluster number setting device according to claim 1, wherein when the unsteady fluctuation detection processing is performed by changing the threshold for the time series data in a period in which a correct answer related to the presence/absence of occurrence of unsteady fluctuation for each time point is known, the program instructions cause the processor to determine whether or not the index is less than the threshold, by using the threshold with which maximum detection accuracy is obtained.

4. A cluster number setting method performed by a computer, the cluster number setting method comprising:
inputting time series data representing a system state, at each time point, of a system configured by one or more devices, the time series data being configured by data of a dimension of the number of devices constituting the system, a dimension of the number of items representing the number of devices×states of the devices, or a dimension of the number of devices×the number of items×a predetermined time window length;
repeatedly clustering data constituting the time series data while counting up the number of clusters from 1 or 2;
calculating a predetermined index by using a result of the clustering;
determining whether or not the index is less than a preset threshold; and
outputting the current number-1 of clusters as the number of clusters to be set for unsteady fluctuation detection processing that uses clustering processing, when the index is determined to be less than the threshold.

5. A non-transitory computer-readable recording medium storing a program which causes a computer to function as the cluster number setting device according to claim 1.
